(19) United States
(12) Patent Application Publication
(10) Pub. No.: US 2020/0293685 A1
(43) Pub. Date: Sep. 17, 2020

(54) GUIDED REDACTION SYSTEMS AND METHODS

(71) Applicant: AMANDA LEVAY, STATEN ISLAND, NY (US)

(72) Inventor: AMANDA LEVAY, STATEN ISLAND, NY (US)

(21) Appl. No.: 16/817,457

(22) Filed: Mar. 12, 2020

Related U.S. Application Data
(60) Provisional application No. 62/817,441, filed on Mar. 12, 2019.

(51) Int. Cl. G06F 21/62; G06F 16/93; G06F 16/25; G06F 40/197; G06F 40/166

(52) U.S. Cl. CPC G06F 21/6245; G06F 16/93; G06F 40/166; G06F 40/197; G06F 16/258

(57) ABSTRACT

Systems and methods for guided, automated redaction are disclosed. A cloud-based software platform allows users to upload a plurality of documents of any file type, collaboratively perform permanent redaction on the documents in real time, and save redacted versions of the documents in their original file types. Users can choose from a plurality of redaction methodologies for identifying information to be redacted, including manual methodology, search methodology, image methodology, pattern methodology and document methodology. Sensitive information in documents of certain types is efficiently found and redacted based on known patterns and known locations of the information as it commonly appears in such documents.

### FIELD OF THE INVENTION

The present invention generally relates to systems and methods for redacting information from documents. More specifically, it relates to a system and method for redacting information from a document using a cloud-based, guided redaction framework.

### CROSS REFERENCE TO RELATED APPLICATIONS

The present application claims priority from the following U.S. Provisional Application, the entire disclosure of which, including but not limited to any and all cited references, is incorporated herein by reference: U.S. Provisional Application No. 62/817,441 (filed Mar. 12, 2019).

### BACKGROUND OF THE INVENTION

Redaction (also known as sanitization) is the obscuring or removal of information in a document. The information can include, but is not limited to, text, images and video. The process of redaction is intended to allow the selective disclosure of certain content in a document while keeping other content in the document undisclosed. Typically, the result is a document that is suitable for publication or for dissemination to others rather than the intended audience of the original document.

During World War II every letter written by an American soldier overseas was read by a censor. Any stray comments about troop positions or movements, battle plans, military objectives, or anything else that might have been useful to the enemy had to be removed in order to preserve military secrecy. Today, digital documents must be redacted. When redacting content from digital documents, it is not sufficient for security or privacy purposes to simply use an editor to draw a black line or black box over sentences and then save the file. The original content remains with the file and is embedded in the file's ‘metadata’. Therefore, anyone with access to the document can copy the data that was redacted, paste it into another document, and read it there instead.

Many forms of digital redaction currently exist. However, they are generally associated with a pre-determined set of file types that are proprietary. The security industry has begun developing ‘decentralized’ forms of redaction that allow users to perform redaction across file types. U.S. Patent Application Publication 2009/0019379 discusses a browser-based redaction software program. However, it is not compatible with today's cloud networks. U.S. Patent Application Publication 2014/0082523 discusses an online redaction program. However, it does not incorporate automatic data string search functionality. U.S. Pat. No. 8,826,443 granted to Raman et al. discusses a browser-based redaction system. However, this system does not function across various cloud network files.

Accordingly, there is a need for a system and method for redacting information that addresses these deficiencies and others.

### SUMMARY OF THE INVENTION

The invention addresses the aforementioned deficiencies and others by providing a system and method for redacting information from a document using a cloud-based, guided redaction framework.

An object of the invention is to permanently redact information from a document. In certain embodiments, a user may provide a document to the system, select information in the document for redaction, and request that a redacted version of the document be generated and made available. In certain embodiments, the system then permanently deletes the information, and any trace of the information, from the document, and generates a redacted version of the document in which the information is replaced with placeholder information. In preferred embodiments, the redaction cannot be reversed, ‘cracked’ by hacking, or otherwise compromised once it is completed.

For example, in certain embodiments, a user may upload a document to the software, highlight content within the document, and instruct the software to redact the content; the software then permanently deletes the highlighted content as well as any information, associated with the highlighted content, that is stored in the document's metadata, generates a redacted version of the document in which the highlighted content is replaced with visible marks such as, for example, Unicode blocks or symbols (e.g., ▮▮), and makes the redacted version of the document available for download by the user.

Another object of the invention is to enable redaction of information from documents of any file type. As used herein, the term “document” can include, but is not limited to, any electronic file of any file type and any electronic copy of any physical document. Documents commonly subject to redaction can include, but are not limited to, Abobe-formatted files (e.g., Portable Document Format (PDF), Photoshop, Illustrator), Microsoft-formatted files (e.g., Word, Excel, PowerPoint), Apple-formatted files (e.g., Pages, Numbers, Keynote), Google-formatted files (e.g., Docs, Sheets, Slides), image files (e.g., TIFF, JPEG, GIF), video files (e.g., MOV) and any other files types from any other file type creator.

For example, in preferred embodiments, the redaction processes can be performed on Abode PDF documents, Microsoft Excel documents, and documents of any other file type. Preferably, the software recognizes documents of any file type. Further preferably, in preferred embodiments, the software does not require or otherwise rely on specific file types in order to perform the redaction processes. That is, preferably, regardless of the file type of the document provided to the system, the system can perform the redaction processes.

Further, in preferred embodiments, the software can, if desired, convert image files or other non-textual documents (e.g., TIFF, JPEG, GIF, and some PDF files) into files that contain redactable text. That is, for example, some image files contain images of text characters and, using optical character recognition or other technologies, the system can convert the character images into editable text that can then be redacted by the system as described herein.

Further, in preferred embodiments, the software does not need to employ a unique, native, proprietary, or other file type or format of its own in order to perform the redaction processes. Accordingly, preferably, the system does not need to convert provided documents to or from such a unique, native, proprietary, or other file type or format of its own, nor require users to store or manipulate documents in such a unique, native, proprietary, or other file type or format.

Further, in preferred embodiments, the software does not need to convert provided documents to or from any document file type or format to another. Further, in preferred embodiments, the system returns the document to the user in the same file type in which the document was provided by the user. Accordingly, preferably, the system does not require users to store or manipulate documents in file types or formats other than file types or formats the user is already using.

Further, in preferred embodiments, the maintenance of the document unchanged from its file type is achieved by the system detecting the file type, associating the file type with a container specific to the file type, obtaining content from the document in a manner specific to the file type, storing the content in a cache, displaying the cached content in the container so as to appear as the content would in the document, tracking in a log desired changes to the cached content, and displaying changed cached content in the container so as to appear as the changed cached content would in the document, the changed cached content being the cached content as modified according to the changes indicated in the log.

Another object of the invention is to guide a user through steps of identifying information to be redacted, marking the identified information to be redacted, performing redaction on the marked information, and saving a redacted version of the document. As used herein, the term “information” can include, but is not limited to, information, data, text, images, video, and any other possible content in a document.

For example, in preferred embodiments, the user is enabled to indicate how information will be identified for redaction. In preferred embodiments, information can be identified by manual methodology, search methodology, image methodology, pattern methodology, and document methodology.

With regard to manual methodology, for example, preferably a user can manually select, highlight or otherwise mark information in the document with a user interface tool such as, for example, a cursor.

With regard to search methodology, for example, preferably a user can input or otherwise provide characters, words, terms, phrases or other search parameters and the system, based on such provided parameters, can search for and locate any corresponding information in the document.

With regard to image methodology, for example, preferably a user can request that the system detect images in a document, and mark them for redaction or present them to the user as redaction candidates. Non-limiting examples of images commonly sought to be redacted include but are not limited to emojis, graphics, videos, vector images, photos, drawings, and diagrams. Further preferably, the user can provide an image to the system and the system can detect in the document images that are the same, similar, or related to the provided image.

With regard to pattern methodology, for example, preferably a user can select, indicate, or otherwise provide a format in which information to be redacted may appear and request that the system find information in the document that appears in the provided format. Non-limiting examples of information commonly found in pre-defined formats include email addresses, social security numbers, and credit card numbers. Further for example, preferably, a user can select, indicate, or otherwise describe a data trend, or the system can identify, detect, or otherwise determine a data trend, and the system can search for and find in the document content in accordance with the data trend.

With regard to documents methodology, for example, preferably a user can indicate the type of document the user has provided, or the system can detect the type of document the user has provided, and the system can, based on pre-established associations of the type of document with formats in which sensitive information is commonly found in the type of document, and with locations in the type of document in which sensitive information is commonly found, find the sensitive information and mark it for redaction or present it to the user as a redaction candidate.

For example, in preferred embodiments, the system can detect that the document is of a certain type (e.g., driver license, bank check, passport, social security card, etc.), and find sensitive information in the document based on known formats or known locations in in which sensitive information commonly is found the type of document. For example, in preferred embodiments, the system can detect that the document is a driver license, and, based on pre-established associations of the system indicating that a driver license number is in a certain format in a driver license, can search for information in the format and find the driver license number. Further, for example, in preferred embodiments, the system can detect that the document is a driver license, and, based on pre-established associations of the system indicating that a driver photo is in a certain location in a driver license, can search for content at that location in the document and find the driver photo. The associations can be established by hard programming, artificial intelligence, machine learning, computer vision, or any other methods or technologies.

In preferred embodiments, one or more of these methodologies can be conducted on multiple documents at a time, or on one or more batches of documents at a time. Further in preferred embodiments, one or more of these methodologies can be incorporated into one or more pre-defined redaction templates, and such templates can be associated with one or more users or groups of users.

Preferably, the system is implemented in a cloud-based network using a standard communication protocol, such as, for example, the Internet. Accordingly, the software is preferably agnostic to the device operating system or Internet browser that is being used. That is, in preferred embodiments, the software is implemented in a manner that does not require the user to use a specific device operating system or a specific Internet browser. Accordingly, preferably, to use the software, users may simply access the Internet from any device using any browser and connect to a computer or group of computers serving the software.

Accordingly, another object of the invention is to provide the software as a subscription-based service. Preferably, because users can access and use the software using only an Internet browser, they do not need to purchase a copy of the software and load it onto a local computer. Rather, preferably, users can log on to the cloud-based system and perform redaction remotely on secure servers from any desired Internet browser. Further preferably, the implementation of the software in such a manner provides a cloud-based file storage location for redacted documents and documents to be redacted, that can be accessed by the user and any other authorized users using the cloud-based network without the need for specialized connections or software. Further preferably, the implementation of the software in this manner provides the ability to upload documents to the cloud-based file storage location from local computers or other network locations, and download documents from the cloud-based file storage location to local computers or other network locations.

Further accordingly, another object of the invention is to enable users to collaborate on the redaction processes described herein. Preferably, the software is implemented on a cloud-based network such that multiple users can be made part of a user group having common access to redacted documents and documents to be redacted, and common usage of the redaction processes. Further, preferably, the user group can adopt certain hierarchies of privilege levels for users, such, for example, administrative users, management users, standard users, etc. For example, preferably, an administrative user can share documents, set rules for which users can and cannot redact files, assign standard users to perform redactions, assign access rights, establish document approval levels, and undertake other administrative tasks. Further for example, preferably, after redactions have been completed by the assigned standard users, the administrative user can decide which redactions become permanent and which ones are discarded. Further preferably, redacted documents and unredacted documents can be stored on the cloud-based file storage location as originals or duplicates for back-up or other purposes, and made available to users with appropriate privileges.

Further preferably, multiple users can conduct redaction processes on an individual document together in real time. Preferably, all redaction processes performed on a document are recorded in a redaction log for future review such as, for example, for auditing or other purposes. For example, preferably, the redaction log records which users selected, marked, or directed redactions and at what time those activities occurred. Further for example, preferably, the redaction log records when the system performed redactions, whether automatically or directed by users, and at what time those activities occurred. Further for example, preferably, if manual redactions were performed by several collaborating users on one day and automatic redactions were performed on another day, the redaction log would include a record of the redactions made by the user, a record of the redactions made by the software, and each record would have a listing of the entities (e.g., user or system) that performed the redactions. Further for example, preferably, using the log of redaction actions, redacted documents can be retrieved to any intermediate redaction point, up to and including to an unredacted state. Further for example, preferably, using the log of redaction actions, multiple points of a redacted document can be stored, each tailored to disclose, or hide, a different amount of document content to different target audiences.

Upon a reading of this disclosure, those skilled in the art will recognize various means for carrying out these intended features of the invention and others. As such, it is to be understood that other methods, applications and systems adapted to the tasks may be configured to carry out the features and are therefore considered to be within the scope and intent of the present invention and are anticipated. With respect to the above description, before explaining at least one preferred embodiment of the herein disclosed invention in detail, it is to be understood that the invention is not limited in its application to the details of construction and to the arrangement of the components in the descriptions or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for the designing of other structures, methods and systems for carrying out the purposes of the disclosed systems and methods. It is important, therefore, that the claims be regarded as including such equivalent construction and methodology insofar as they do not depart from the spirit and scope of the present invention. As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”′. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements.

The objects, features, and advantages of the present invention, including the advantages thereof over existing prior art, which will become apparent from the descriptions herein, are accomplished by the improvements described in this specification including in the following detailed description which discloses the invention, but should not be considered as placing limitations thereon.

### BRIEF DESCRIPTION OF THE DRAWINGS

The accompanying drawings, which are incorporated herein and form a part of the specification, illustrate some, but not the only or exclusive, examples of embodiments and/or features.

FIG. 1 illustrates multiple users performing redactions collaboratively using an embodiment of the system of the invention.

FIG. 2 illustrates an embodiment of a software user interface of an embodiment of the system of the invention.

FIG. 3 illustrates certain group collaboration and networking features of an embodiment of the system of the invention.

FIG. 4 illustrates functional elements of a preferred embodiment of a system of the invention.

FIG. 5 illustrates a user interface showing a plurality of methodology selection panels of a preferred embodiment of a system of the invention.

FIG. 6 illustrates a user interface showing a plurality of document type selection panels of a preferred embodiment of a system of the invention.

FIG. 7 illustrates a process of maintaining a file type of a document in accordance with a preferred embodiment of a system of the invention.

FIG. 8A illustrates Redaction API, Redaction Wizard, Document Search Engine, Document Manipulation Engine, and Tracking Database features of an embodiment of a system of the invention.

FIG. 8B illustrates an implementation of a process of maintaining a file type of a document, with the features illustrated by FIG. 8A, in an embodiment of a system of the invention.

FIGS. 9-15 illustrate user login (FIG. 9), user registration (FIG. 10), user dashboard (FIG. 11), file management (FIG. 12), project management (FIG. 13), collaboration management (FIG. 14), and account settings (FIG. 15) functionalities of an embodiment of a system of the invention.

FIG. 16 illustrates redaction of content from a Microsoft Excel document file using an embodiment of a system of the invention.

FIGS. 17, 18 and 19 illustrate redaction of content from an Adobe PDF document file using an embodiment of a system of the invention.

FIG. 20 illustrates an application flow of an embodiment of a system of the invention.

FIGS. 21-23 illustrate a functionality of finding text in a PDF document in an embodiment of a system of the invention.

FIGS. 24-26 illustrate undo action and redo action functionalities of an embodiment of a system of the invention.

Other aspects of the present invention shall be more readily understood when considered in conjunction with the accompanying drawings, and the following detailed description, neither of which should be considered limiting.

### DETAILED DESCRIPTION OF PREFERRED EMBODIMENTS

Following are more detailed descriptions of various related concepts related to, and embodiments of, methods and apparatus according to the present disclosure. It should be appreciated that various aspects of the subject matter introduced above and discussed in greater detail below may be implemented in any of numerous ways, as the subject matter is not limited to any particular manner of implementation. Examples of specific implementations and applications are provided primarily for illustrative purposes.

In this description, the directional prepositions of up, upwardly, down, downwardly, front, back, top, upper, bottom, lower, left, right and other such terms may refer to aspects of the system as they are oriented and appear in the drawings and are used for convenience only; they are not intended to be limiting or to imply that such aspects must be used or positioned in any particular orientation.

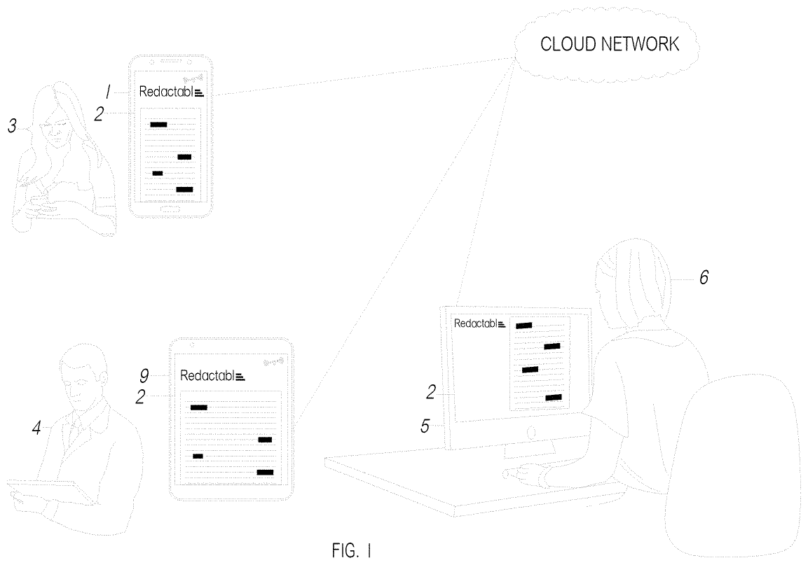

FIGS. 1, 2 and 3 illustrate various aspects of the cloud-based functionalities of preferred embodiments of the system of the invention.

FIG. 1 illustrates multiple users 3, 4 and 6 performing redactions collaboratively using an embodiment of the system of the invention. It should be understood that other embodiments can include as few as one user, or any number of users up to an infinite number of users, in accordance with appropriate user configuration settings. In the illustrated embodiment, the invention includes software 2 residing on a cloud network and being served wirelessly to devices being operated by the users. It should be understood that any manner of transmission is contemplated by the invention, whether now known or hereafter developed.

Preferably, the software is written in code that may include, but not be limited to, C#, JavaScript, Visual Basic, C++, and the like. It should be understood that software of the invention can be written in any code language, whether now known or hereafter developed.

Preferably, the software is compatible with a plurality of operating systems such as, but not limited to, Windows, macOS, iOS and Android operating systems. Preferably, the software is compatible with a plurality of hardware platforms including, but not limited to, desktop computers 5, laptop computers, tablets 9, smartphones 1, and similar devices. Preferably, the software is compatible with a plurality of Internet browsers, including but not limited to, Internet Explorer, Google Chrome, Mozilla Firefox, Apple Safari, and others. It should be understood that use of the invention with any hardware is contemplated by the invention, whether now known or hereafter developed.

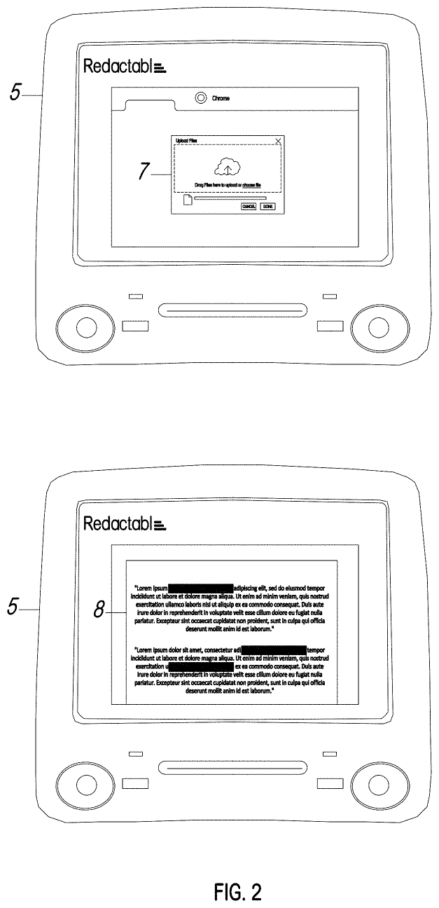

FIG. 2 illustrates an embodiment of a software user interface of the invention being presented in an Internet browser running on a desktop computer 5. An upload screen 7 of the user interface allows users to upload documents from a plurality of sources such as, but not limited to, local drives and cloud servers (e.g., Google Drive, Dropbox, Apple iCloud, Box, etc.). A document 8 in a redacted state is shown. The document 8 has been redacted in accordance with preferred processes of the invention described herein. As illustrated, the content that was redacted has been replaced with Unicode blocks. It should be understood that the redacted content can be replaced with any replacement content, including, replacement content that is customized according to a user's preferences.

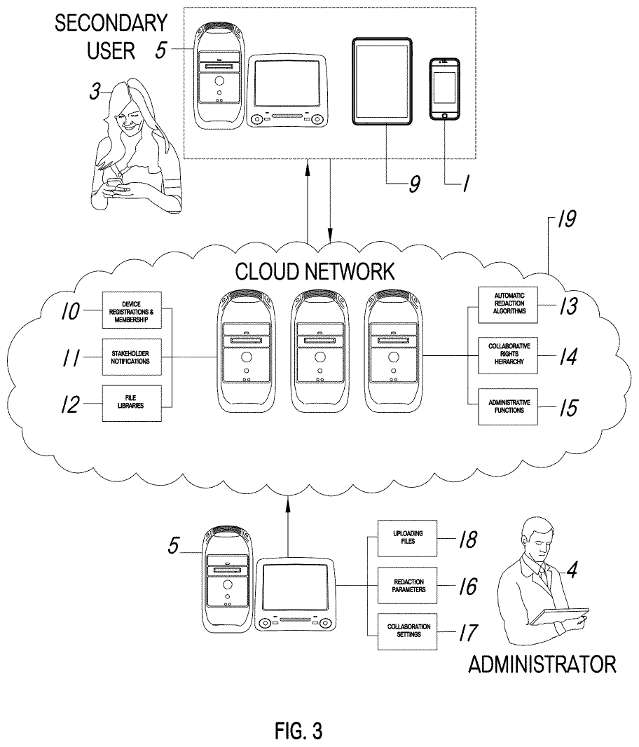

FIG. 3 illustrates certain group collaboration and networking features of an embodiment of the invention. User 4 is illustrated as assigning to himself the role of administrator and performing functions such as, but not limited to: uploading a plurality of documents 18 of various of file types across a plurality of local and remote online networks; setting redaction parameters 16 (including, but not limited to, manual selections, algorithm-governed selections based on phrase trends and pattern identification etc.); and setting collaboration settings 17 (including, but not limited to, redaction permissions, user hierarchies, and the like). Administrative user 4 and secondary user 3 are illustrated as interacting with a system of the invention residing on cloud network 19. The system is illustrated as effecting a plurality of processes such as, but not limited to: device registrations and membership management 10; stakeholder notifications 11 (including but not limited to short message service (SMS), text messaging, email notifications, etc.); file library operations 12 (including, but not limited to, archiving original and duplicate redacted and unredacted files, etc.); activation of automatic redaction algorithms 13 (including, but not limited to, data pattern searching, content format searching, image searching, text trend searching, code searching, document detection, image detection, etc.); the aforementioned collaborative rights hierarchy assignments 14; and administrative functions 15 (including, but not limited to, member payments and financial transactions, etc.).

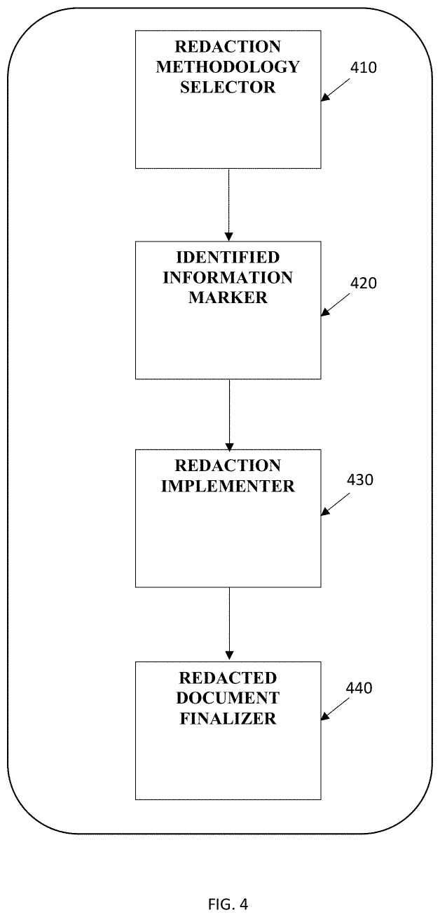

Referring now to FIG. 4, in preferred embodiments, the system of the invention includes a redaction methodology selector 410, an identified information marker 420, a redaction implementer 430, and a redacted document finalizer 440.

It should be noted that elements of the system indicated as functional blocks for performing various processing operations may be implemented in any now known or hereafter developed manner, including but not limited to by hardware such as, for example, a circuit and memory, by software such as, for example, a program loaded into memory, or a combination of both hardware and software. That is, it will be understood by those skilled in the art that the functional blocks may be variously implemented by hardware only, by software only, or by a combination of hardware and software. The method of implementing the functional blocks is not limited. Communication among elements may be provided through a communications network such as, for example, the Internet by using any now known or hereafter developed communication protocols such as, for example, World Wide Web, Hypertext Markup Language (HTML) and Cascading Style Sheet (CSS) protocols, or provided by being stored in and/or provided through a computer-readable information storage medium such as, for example, a data storage device.

The redaction methodology selector is preferably configured to select a desired redaction methodology for identifying information to be redacted. The identified information marker is preferably configured to mark the identified information for redaction. The redaction implementer is preferably configured to perform redaction on the marked information. The redacted document finalizer is preferably configured to save a redacted version of the document, in which the marked information has been replaced with desired placeholder information. Preferably, the desired placeholder information includes at least one of Unicode text, a set of one or more solid boxes, a set of one or more characters conveying information, a set of one or more characters spelling a phrase of one or more terms, a randomized set of one or more characters, a set of one or more space characters, blurred text, and blurred image.

Referring now to FIG. 5, the redaction methodology selector is preferably configured to select a desired redaction methodology for identifying information to be redacted. Preferably, the desired methodology is selected from a selection set including at least one of manual methodology, search methodology, image methodology, pattern methodology and document methodology.

Preferably, the redaction methodology selector is configured to accept, as the selection of the desired methodology, a user selection of the desired methodology. For example, FIG. 5 illustrates a web page that shows a user interface for the system of the invention, which presents a plurality of methodology selection panels. For example, the interface presents a manual methodology selection panel 510, a search methodology selection panel 520, an image methodology selection panel 530, a pattern methodology selection panel 540 and a document methodology selection panel 550. A user can selects the methodology selection panel associated with the methodology the user wishes to use. It should be noted that fewer or more methodology selections panels, of these or other types, without or without other user interface elements, are contemplated by the invention. In other embodiments, the redaction methodology selector may select a methodology for the user, based on one or more variables, conditions, or criteria.

Preferably, if the selected methodology is manual methodology, the information to be redacted is any content in the document, and the information is identified by a user navigating the document and selecting the content. It should be understood that any now known or hereafter developed methods of document navigation and document content selection are contemplated by the invention. A non-limiting example of document navigation is scrolling the document in a web browser. Non-limiting examples of document content selection include a user manually selecting, highlighting or otherwise marking information in the document with a user interface tool such as, for example, a cursor by, for example, passing over or clicking on an item of content to select the item.

Further preferably, if the selected methodology is manual methodology, the content includes one or more of a set of one or more characters, images, and pages. For example, the characters can be of any length and of any language. Also, for example, the images can be of any dimension, resolution, or format. Also, for example, the pages can be selected one or more at a time.

Preferably, if the selected methodology is search methodology, the information to be redacted is one or more terms, and the information is identified by a user providing the terms, the system searching in the document for the terms, and the system finding in the document all instances of the terms. It should be understood that any now known or hereafter developed manner of providing search terms is contemplated by the invention, and that any now known or hereafter developed manner of searching for terms in a document is contemplated by the invention.

Further preferably, if the selected methodology is search methodology, the terms are provided by the user inputting one or more characters of a search phrase of one or more terms. For example, in preferred embodiments, the user can input or otherwise provide characters, words, terms, phrases or other search parameters and the system, based on such provided parameters, can search for and locate any corresponding information in the document. A non-limiting example of the user providing search terms is the user being presented with a search box and inputting a search phrase into the search box.

Further preferably, the terms can be provided by the user for multiple queries, and multiple queries can be undertaken by the software substantially simultaneously.

Preferably, if the selected methodology is image methodology, the information to be redacted is one or more images, and the information is identified by the system detecting in the document the images.

Further preferably, if the selected methodology is image methodology, the images are detected by one or more of the following: hard programming, artificial intelligence, machine learning, computer vision, or any other methods or technologies.

Further preferably, a user can request that the system detect images in a document, and mark them for redaction or present them to the user as redaction candidates. Non-limiting examples of images commonly sought to be redacted include but are not limited to emojis, graphics, videos, vector images, photos, drawings, and diagrams. Further preferably, the user can provide an image to the system and the system can detect in the document images that are the same, similar, or related to the provided image.

Preferably, if the selected methodology is pattern methodology, the information to be redacted is content in a format, and the information is identified by a user identifying the format, the system searching in the document for any content in the format, and the system finding in the document all content in the format.

Further preferably, a user can select, indicate, or otherwise provide a format in which information to be redacted may appear and request that the system find information in the document that appears in the provided format.

Further preferably, if the selected desired methodology is pattern methodology, the format is one or more of email address format, phone number format, name format, date format, currency format, Uniform Resource Locator format, Internet Protocol format, credit card number format, debit card number format, company name format, address format, zip code format, postal code format, location format, government-issued identification number format, company-issued identification number format, social security number format, and identification number format.

It should be understood that any and all information formats are contemplated by the invention, whether now known or hereafter developed.

Preferably, if the selected methodology is document methodology, the information to be redacted is sensitive content found in one or more documents of a type of document, and the information is identified by a selection of the type of document and the system detecting the sensitive content based on the type of document. Preferably, the information to be redacted is sensitive content that is normally, usually, typically, routinely, commonly, often, historically, on-average, etc. (such terms and their equivalents being referred to herein as “commonly”) found in the specified type of document. Non-limiting examples of documents that commonly contain sensitive content include driver licenses, bank checks, passports, company formation documents, social security cards, birth certificates, bank records, and medical records.

Non-limiting examples of sensitive content commonly found in a driver license include a photo of the driver, a name of the driver, an address of the driver, and a driver license number. Non-limiting examples of sensitive content commonly found in a passport include a photo of the passport holder, a name of the passport holder, an address of the passport holder, and a passport number.

Further preferably, if the selected desired methodology is document methodology, the selection of the type of document is achieved by one or more of the user selecting the type of document and the system detecting the type of document.

For example, preferably a user can indicate the type of document the user has provided, or the system can detect the type of document the user has provided, and the system can, based on pre-established associations of the type of document with formats in which sensitive information is commonly found in the type of document, and with locations in the type of document in which sensitive information is commonly found, find the sensitive information and mark it for redaction or present it to the user as a redaction candidate.

Further preferably, if the selection of the type of document is achieved by the user selecting the type of document, the manner of selection is the user selecting a user interface element associated with the type of document.

For example, in preferred embodiments, the user is presented with one or more document type selection panels, each associated with a different type of document, and the user selects the document type selection panel associated with the type of document the user has provided for redaction.

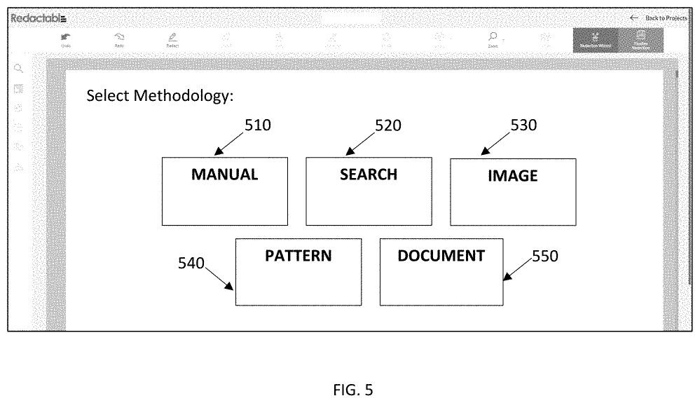

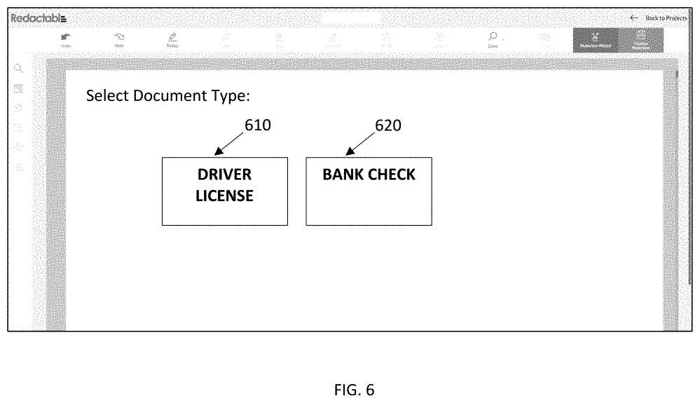

For example, FIG. 6 illustrates a web page that shows a user interface for the system of the invention, which presents a plurality of document type selection panels. For example, the interface presents a driver license selection panel 610 and a bank check selection panel 620. A user selects the driver license selection panel to select driver license as the type of document, or selects the bank check selection panel to select bank check as the type of document. It should be noted that fewer or more document type selections panels, of these or other types, without or without other user interface elements, are contemplated by the invention.

Further preferably, if the selection of the type of document is achieved by the system detecting the type of document, the type of document is detected by one or more of the following: hard programming, artificial intelligence, machine learning, computer vision, or any other methods or technologies.

Further preferably, if the selected desired methodology is document methodology, the sensitive content is information known to be in a least one of a known format and a known location in the type of document.

Further preferably, the known information is so known based on a pre-established association of one or more of the known format and the known location with the type of document. Associations can be established by hard programming, artificial intelligence, machine learning, computer vision, or any other methods or technologies.

It should be understood that the invention encompasses using, to any degree, for the purposes of locating or otherwise being aware of sensitive content in the type of document, format, location, and any and all other aspects of content that can be known about the content. Associations with any and all such aspects can be established by hard programming, artificial intelligence, machine learning, computer vision, or any other methods or technologies.

Further preferably, the sensitive content is information detected by, when the known information is information known to be in the known format in the type of document, the system searching in the document for any content in the known format, and the system finding in the document all content in the known format.

Further preferably, the known format is one or more of email address format, phone number format, name format, date format, currency format, Uniform Resource Locator format, Internet Protocol format, credit card number format, debit card number format, company name format, address format, zip code format, postal code format, location format, government-issued identification number format, company-issued identification number format, social security number format, and identification number format. It should be understood that the invention encompasses any and all formats, whether now known or hereafter developed.

Further preferably, the sensitive content is information detected by, when the known information is known to be in the known location in the type of document, the system searching in the document for any content in the known location, and the system finding in the document all content at the known location.

For example, in preferred embodiments, the system can detect that the document is of a certain type (e.g., driver license, bank check, passport, social security card, etc.), and find sensitive information in the document based on known formats or known locations in in which sensitive information commonly is found the type of document. For example, in preferred embodiments, the system can detect that the document is a driver license, and, based on pre-established associations of the system indicating that a driver license number is in a certain format in a driver license, can search for information in the format and find the driver license number. Further for example, in preferred embodiments, the system can detect that the document is a driver license, and, based on pre-established associations of the system indicating that a driver photo is in a certain location in a driver license, can search for content at that location in the document and find the driver photo. The associations can be established by hard programming, artificial intelligence, machine learning, computer vision, or any other methods or technologies.

Preferably, the document is provided by the user to the system in a file type, and the redacted version of the document is saved in the file type, and during identifying the information to be redacted, marking the identified information to be redacted, performing redaction on the marked information, and saving the redacted version of the document, the file type of the document is maintained unchanged from the file type. It should be understood that the invention also encompasses maintaining the file type unchanged in one, some, or all of these steps, in any permutation.

Further preferably, the file type is one of an Adobe file type, a Microsoft file type, an Apple file type, and an open-source file type. At least one of the file types is preferably Portable Document Format (PDF). It should be understood that the invention encompasses any and all file types, whether now known or hereafter developed.

Further preferably, the maintenance of the document unchanged from the file type is achieved by detecting the file type, associating the file type with a container specific to the file type, obtaining content from the document in a manner specific to the file type, storing the content in a cache, displaying the cached content in the container so as to appear as the content would in the document, tracking in a log desired changes to the cached content, and displaying changed cached content in the container so as to appear as the changed cached content would in the document, the changed cached content being the cached content as modified according to the changes indicated in the log.

Preferably, the container is configured to accept the cached content as input and apply conditions to present the cached content as it would appear in the file type to which the container is specific. The invention encompasses conditions of any kind, whether now known or hereafter developed. Non-limiting examples of conditions include formatting, font changes, font size changes, spacing, positioning, stylization, and coded modifications.

Further preferably, tracking the desired changes in the log includes recording at least one of a location of the change and the change to be made. All other tracking information and data and the recording thereof in the log are encompassed by the invention, whether now known or hereafter developed.

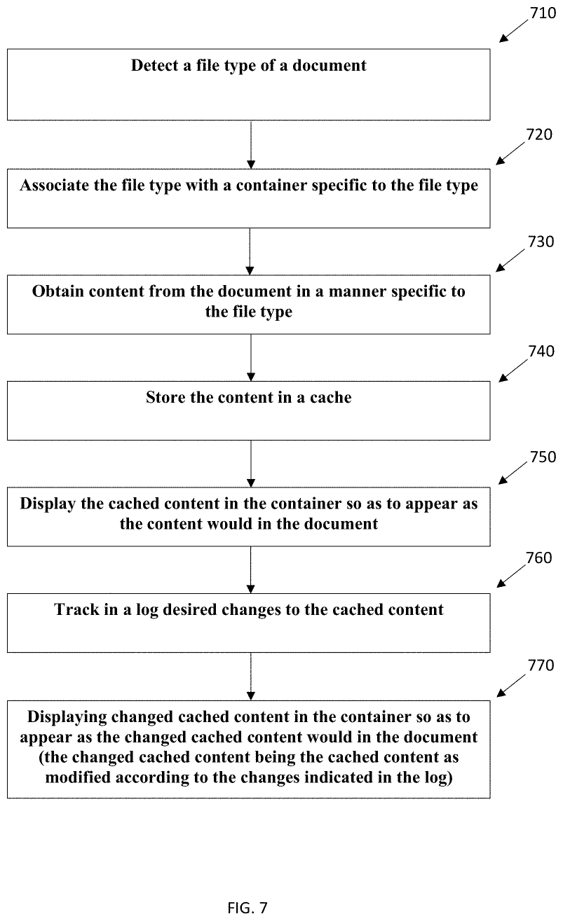

For example, FIG. 7 illustrates a preferred process of maintaining a file type of a document, showing steps of detecting the file type 710, associating the file type with a container specific to the file type 720, obtaining content from the document in a manner specific to the file type 730, storing the content in a cache 740, displaying the cached content in the container so as to appear as the content would in the document 750, tracking in a log desired changes to the cached content 760, and displaying changed cached content in the container so as to appear as the changed cached content would in the document 770, the changed cached content being the cached content as modified according to the changes indicated in the log.

It should be noted that the invention also contemplates embodiments in which one, some or all of the above steps, in any possible permutation, are used to maintain a file type of a document.

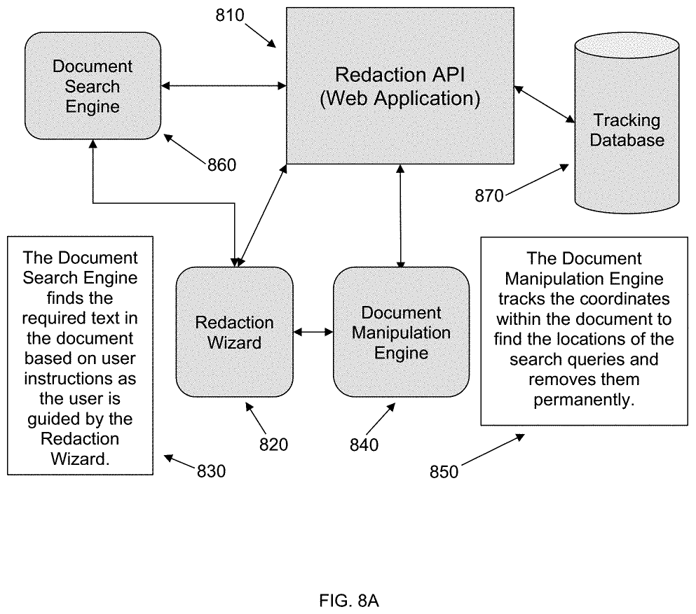

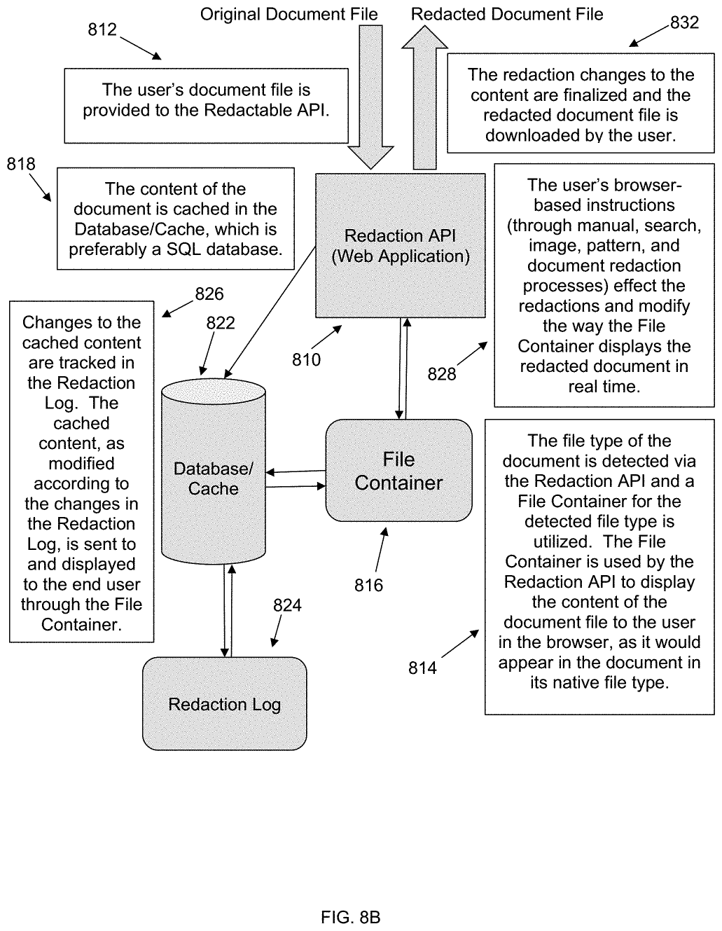

Referring now to FIG. 8A, certain features of an embodiment of the invention are illustrated. The Redaction Application Programming Interface (API) 810 preferably is a web application that uses .NET Core on the back end and uses Angular 6 on the front end. The Redaction API serves as a primary component of a redaction methodology selector, effecting the selection of a desired redaction methodology for identifying information to be redacted; an identified information marker, effecting the marking of identified information for redaction; a redaction implementor of the invention, performing redaction on identified information that has been marked for redaction; and a redacted document finalizer, saving redacted versions of a document in which the marked information has been replaced with placeholder information.

Preferably, the Redaction API effects the selection of a desired redaction methodology for identifying information to be redacted. Preferably, the Redaction API utilizes a Redaction Wizard 820. The Redaction Wizard guides a user through the selection and use of the above described redaction methodologies, and for the document methodology, effects the suggesting to users what information should be redacted from a document based on the type of document (e.g., driver license, bank check, etc.). The Redaction Wizard preferably uses Optical Character Recognition (OCR), Google Vision, Open CV, and Machine Learning (ML) algorithms to automatically detect content and send the content to the Redaction API and the Document Manipulation Engine 840 for redaction.

For example, preferably, when processing a Driver License or other identification card, the Redaction Wizard performs one or more of the following functions, among other functions: (1) automatically detects the location of certain textual information, such as first name, last name, address, date of birth, and driver license number (or other identification number); (2) automatically detect the photo on the license or card and automatically and permanently obscure it (e.g., by blurring it in a manner that cannot be reversed); (3) automatically recognize a signature on the license or card (e.g., using Google Vision) and automatically and permanently obscure it (e.g., by blurring it in a manner that cannot be reversed).

Further for example, preferably, when processing a Bank Check, the Redaction Wizard performs one or more of the following functions, among other functions: (1) automatically detects the Magnetic Ink Character Recognition (MICR) font which includes the account number and routing number; (2) automatically detect the address and other personal information located on the top left of the bank check; (3) automatically recognize handwritten objects (e.g., using Google Vision) and automatically and permanently obscure them (e.g., by blurring them in a manner that cannot be reversed).

Further preferably, the Redaction API effects the marking of identified information for redaction. Preferably, the Redaction API uses a Document Search Engine 860, as indicated in element 830. The Document Search Engine preferably is a library installed within the Redaction API, and preferably utilizes an open source viewer and has its own server functionality. The Document Search Engine enables searching within the document, finds and highlights in the document the search terms, and marks the locations of the terms. The Document Search Engine functionality is preferably used to improve the user's search experience and easily highlight multiple search terms. Using the functionality, content (e.g., from a PDF file) preferably can be highlighted and updated in real time. The functionality simplifies the process of viewing (e.g., of PDF files) because it can highlight keywords within text. The functionality preferably can assign separate colors to different keywords, further enhancing and organizing search results. Using the functionality, users preferably can seamlessly navigate between matching terms. The Document Search Engine functionality preferably is integrated by loading the viewer into the application in which the document (e.g., a PDF) will be rendered (e.g., placing the viewer code in the assets folder in the Angular application), configuring the highlighting functionality (installing its executable file in the system to create the environment for the functionality), and setting up a reverse proxy environment that will call the highlighting functionality.

Further preferably, the Redaction API removes the marked information, permanently deletes it from the document file, and makes a redacted version of the document available. Preferably, the Redaction API uses a Document Manipulation Engine 840, as indicated in element 850. The Document Manipulation Engine preferably is a library installed within the Redaction API, and preferably is a .NET library for manipulating PDF files. Content that is marked for redaction is provided to the Document Manipulation Engine, and the Document Manipulation Engine removes and permanently deletes the content from the document, saves a redacted version of the document, and makes the redaction version of the document available for download.

Further preferably, the Redaction API utilizes a Tracking Database 870 that tracks and records user behaviors with regard to the redaction of content from document and analyzes the resulting data to enhance the ability of the Redaction Wizard to automatically detect sensitive content in documents and suggest content for possible redaction.

Referring now to FIG. 8B, an implementation of a process of maintaining a file type of a document, with the features illustrated by FIG. 8A, is illustrated. Once a user provides a document to the Redaction API 810, as indicated in element 812, the Redaction API detects the file type as indicated in element 814. The Redaction API then associates the file type with a File Container 816 that is specific to the file type (e.g., each File Container handles all documents of a specific file type). Further, the Redaction API obtains content from the document in a manner specific to the file type (e.g., is programmed or otherwise trained to know, for that file type, where the content is and how to access it, and accordingly obtains the content from the document via such access) and, as indicated in element 818 stores the content in a Database/Cache 822, which is preferably a SQL database. The Redaction API further displays the cached content in the File Container so as to appear as the content would in the document, as indicated in element 814. As the user provides instructions to effect redactions (through manual, search, image, pattern, and document redaction processes), as indicated in element 828, the File Container updates the display of the document contents in real time. That is, the Redaction API tracks in a Redaction Log 824 desired changes to the cached content, as indicated in element 826, and, further as indicated in element 826, the Redaction API displays changed cached content (i.e., the cached content as modified according to the changes indicated in the Redaction Log) in the File Container so as to appear as the changed cached content would in the document. When the user has completed the redactions, the redaction changes to the content are finalized and the redaction document is made available for download by the user, as indicated by element 832.

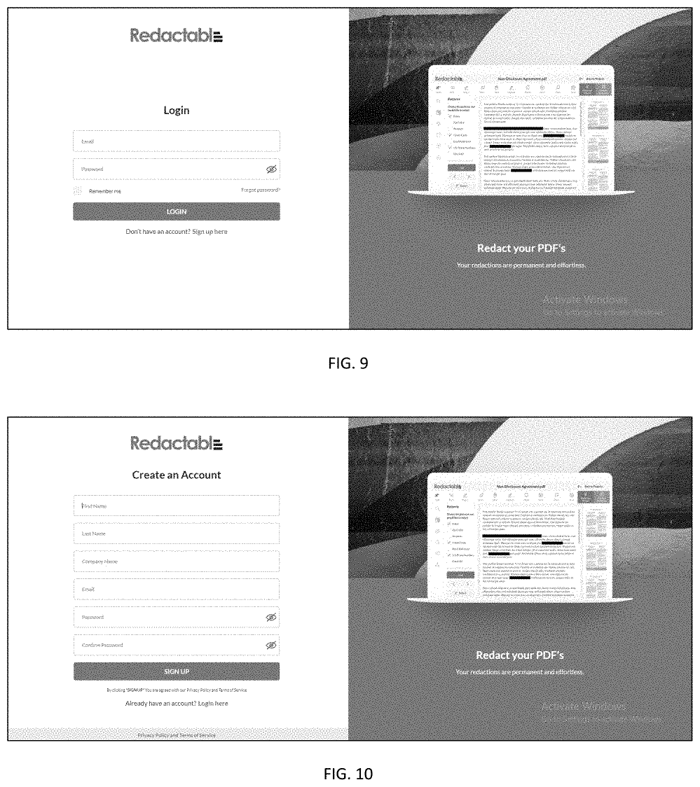

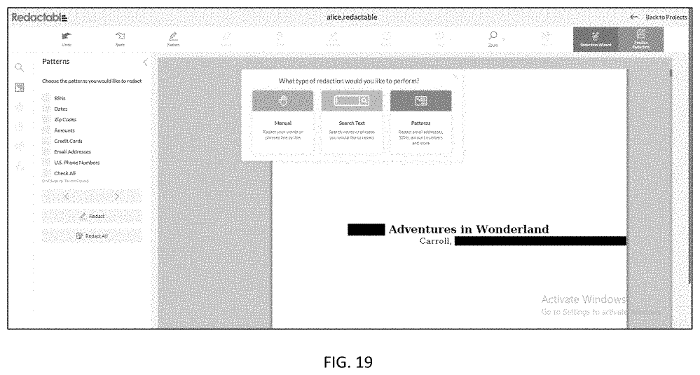

FIGS. 9-27 illustrate and describes a preferred implementation of an embodiment of the invention.

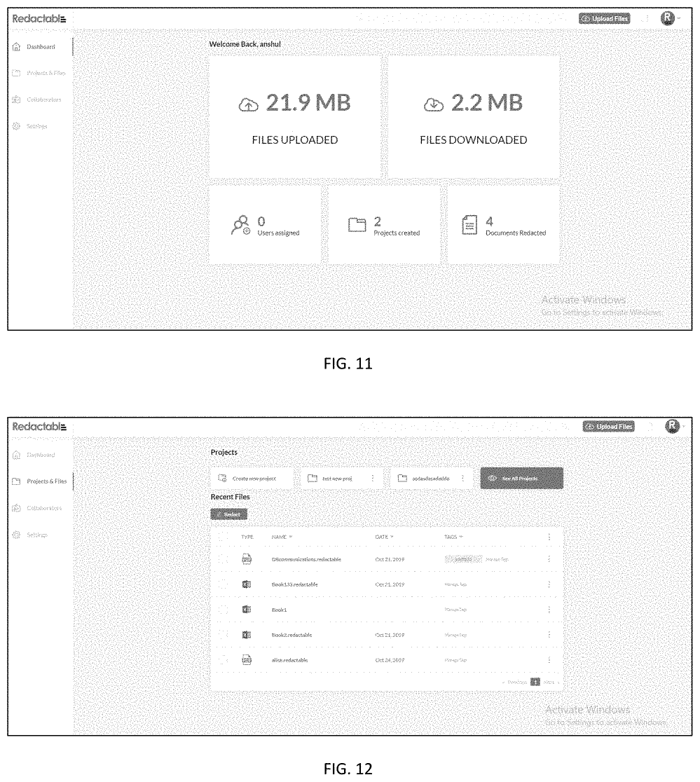

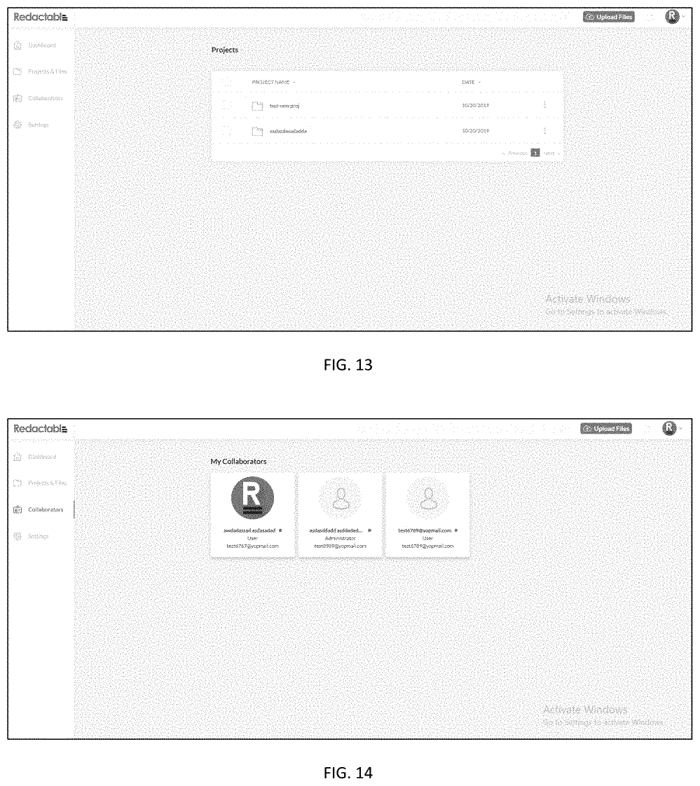

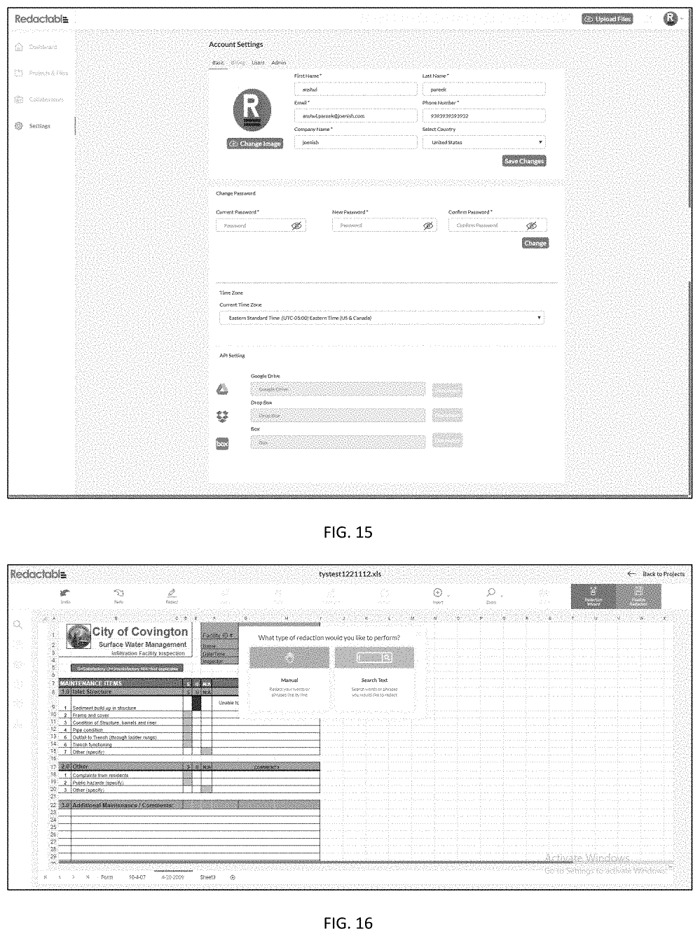

Referring now to FIGS. 9-15, the implementation provides user login (FIG. 9), user registration (FIG. 10), user dashboard (FIG. 11), file management (FIG. 12), project management (FIG. 13), collaboration management (FIG. 14), and account settings (FIG. 15) functionalities for each user.

FIG. 16 illustrates redaction of content from a Microsoft Excel document file using the implementation.

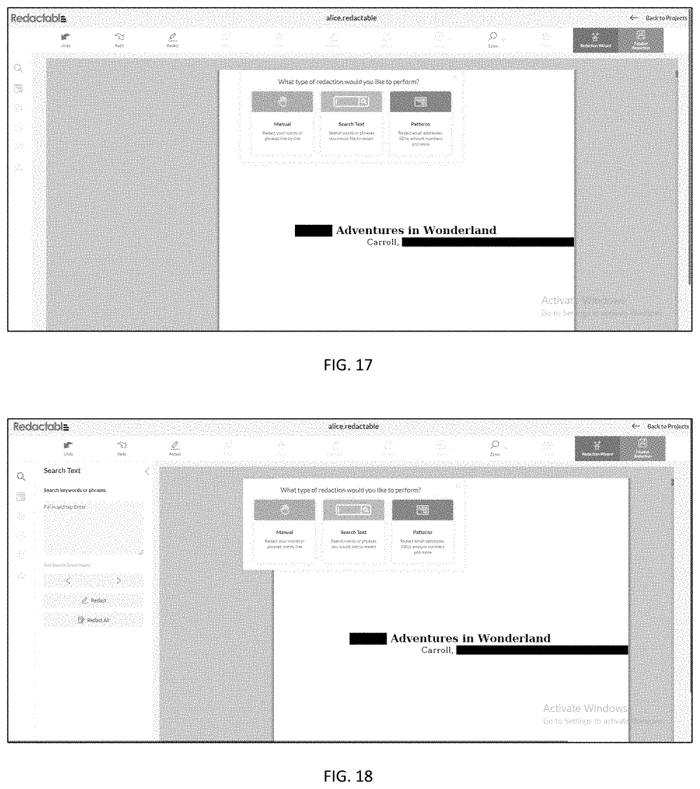

FIGS. 17, 18 and 19 illustrate redaction of content from an Adobe PDF document file using the implementation, including use of the implementation for search redaction methodology and pattern redaction methodology.

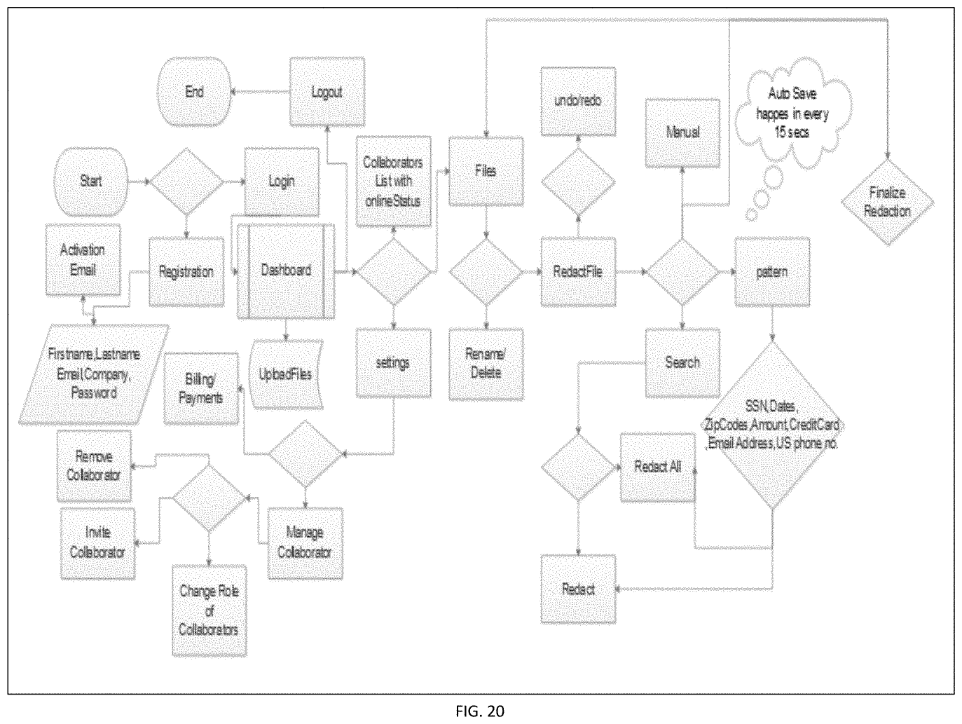

FIG. 20 illustrates an application flow of certain aspects of the implementation, showing relationships between components, decision making of components, and the passing of data between components.

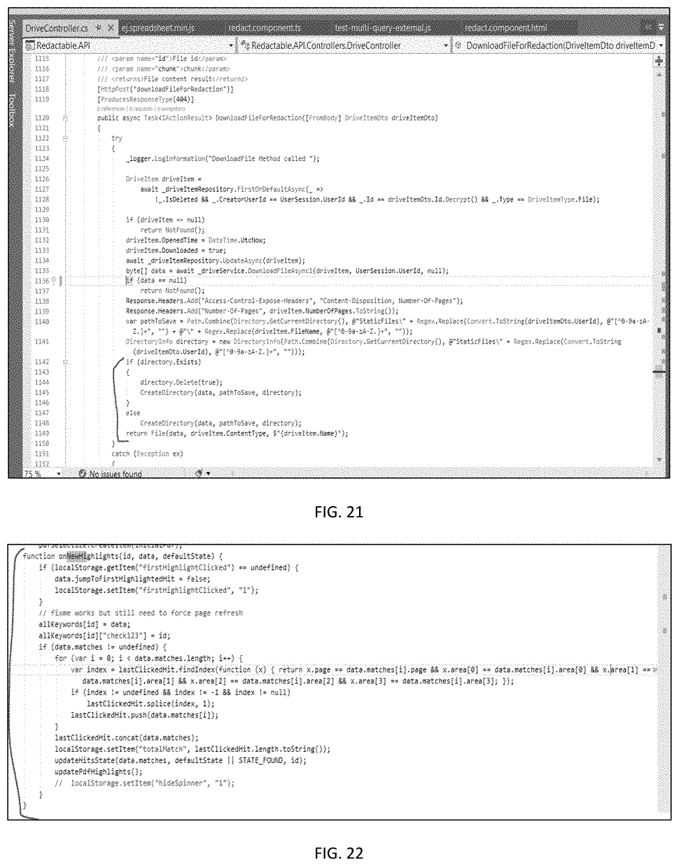

FIGS. 21-26 illustrate certain features of the implementation.

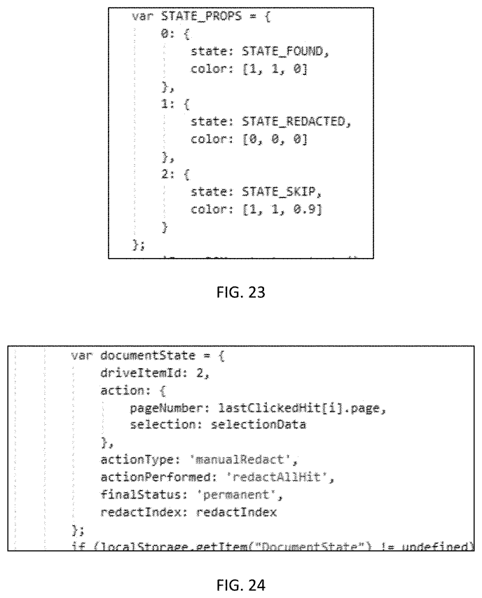

FIGS. 21-23 illustrate a functionality of finding text in a document (e.g., a PDF document). To make use of the highlighting functionality, its scripts are loaded into the Redaction API once the document viewer (e.g., PDF viewer) is loaded. Once the scripts and the viewer are loaded, the file is referenced from the API folder. Once a user clicks on a redaction action button (or other user interface element) on the file, or once a user selects the file, for the redaction process, in the files list, the file is downloaded from cloud storage. One copy of the file is saved in a static folder in the API so that the file can be referenced from the static folder available in the API to the viewer. (See FIG. 22.) Once a user searches any text, performs a manual redaction, or conducts any pattern search, a post request is made with the help of the proxy server to the highlighter functionality service running, which searches through the document and creates a temporary cache of the file and provides all the matches in a form of a JavaScript Object Notation (JSON) response. (See FIGS. 23-24.)

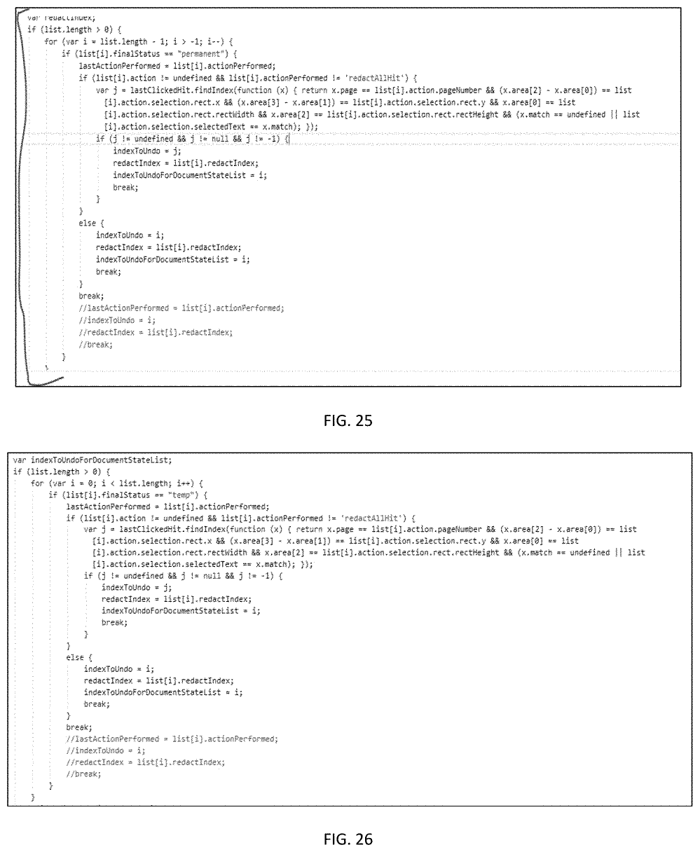

FIGS. 24-26 illustrate undo action and redo action functionalities. Once the user performs any highlights, searches, redactions, or other actions, a document log with the state of the document is maintained and stored in the local storage of the browser, the match is set as permanent, and the user can undo the action. (See FIG. 25.) If the user selects Undo, the last action performed is checked. If the last action performed is a permanent action the system marks it as temporary and updates the document log with the appropriate state. If the last action performed is not a permanent action but is a temporary action, the system checks the nth position where the action is permanent and marks it as temporary, and updates the document log with the appropriate state. (See FIG. 26.) If the user selects Redo, the last action performed is checked. If the last action performed is a temporary action, the system marks it as permanent and updates the document log with the appropriate state. If the last action performed is not a temporary action but is a permanent action, the system checks the nth position where the action is temporary and marks it as temporary, and updates the document log with the appropriate state. (See FIG. 27.)

While not illustrated, the implementation further includes a redaction finalization functionality. If a user selects Finalize, a finalize redaction method is called. The document state log is checked once the method is called. If a specific match is found in the document state log and the match is a permanent match, a payload is created and is sent to the server-side code for final redaction. Once a payload is created, a post request is created to a controller available in the Redaction API. The Document Manipulation Engine handles the request for text replacement of the payload, serves the request, and permanently removes the content from the document.

While not illustrated, the implementation further includes a Bates numbering functionality. Preferably, users can add Bates number to a document (e.g., an Adobe PDF document or a Microsoft Excel document). Further preferably, a user can add prefixes and suffixes to the Bates numbers and can also select the page number while adding the Bates number, where the page number is the sheet index (e.g., the starting sheet index). Preferably, in the case of a Microsoft Excel document, three rows are added at the top of each sheet in the workbook file and the Bates numbers are added in the first cell of the sheets.

While not illustrated, the implementation further includes an auto-save, or automatic document saving, functionality. Preferably, this functionality keeps track of user actions performed on a document, checks the document state log, and saves the document state log in a database. Preferably, the logs for specific documents are updated at regular intervals (e.g., every 15 seconds). Preferably, the user can close the Internet browser through which the user is accessing the redaction system, or cancel a redaction process, and when the user later resumes use of the redaction system and accesses the document, the document will be restored to its last modified state. For example, the redactions last performed by the user will be restored once the document is opened again in the redaction window. To accomplish this, preferably, once the document is opened in the redaction window, the document state logs are checked in the database. If the logs are available in the database for the specific document, a restore method is called.

It is additionally noted and anticipated that although the invention is shown and described in its most simple form, various components and aspects of the invention may be differently configured or slightly modified when forming the invention herein. As such, those skilled in the art will appreciate that the descriptions and depictions set forth in this disclosure are merely meant to portray examples of preferred modes within the overall scope and intent of the invention, and are not to be considered limiting in any manner. It should be understood, in the descriptions in which steps are described as accomplishing or being undertaken for the purposes of an objective, the invention encompasses embodiments in which all of the steps are taken, in any and all possible permutations, and in which less than all of the steps are taken, in any and all possible permutations. It should further be understood, with regard to the descriptions in which examples are given, the invention encompasses embodiments using any and all possible examples, whether now known or hereafter developed, falling within the most general category occupied by such examples. It should further be understood, with regard to the descriptions in which criteria are used, the invention encompasses embodiments using any and all possible criteria, whether now known or hereafter developed, falling within the most general category occupied by such criteria. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention.

1. A system for redacting information from a document, the system comprising:
a redaction methodology selector configured to select a desired redaction methodology for identifying information to be redacted, the desired methodology being selected from a selection set including at least one of manual methodology, search methodology, image methodology, pattern methodology and document methodology,
an identified information marker configured to mark the identified information for redaction,
a redaction implementer configured to perform redaction on the marked information, and
a redacted document finalizer configured to save a redacted version of the document, in which the marked information has been replaced with desired placeholder information;
wherein when the selected methodology is manual methodology, the information to be redacted is any content in the document, and the information is identified by a user navigating the document and selecting the content,
wherein when the selected methodology is search methodology, the information to be redacted is one or more terms, and the information is identified by a user providing the terms, the system searching in the document for the terms, and the system finding in the document all instances of the terms,
wherein when the selected methodology is image methodology, the information to be redacted is one or more images, and the information is identified by the system detecting in the document the images,
wherein when the selected methodology is pattern methodology, the information to be redacted is content in a format, and the information is identified by a user identifying the format, the system searching in the document for any content in the format, and the system finding in the document all content in the format,
wherein when the selected methodology is document methodology, the information to be redacted is sensitive content found in one or more documents of a type of document, and the information is identified by a selection of the type of document and the system detecting the sensitive content based on the type of document.

2. The system of claim 1, wherein the redaction methodology selector is configured to accept, as the selection of the desired methodology, a user selection of the desired methodology.

3. The system of claim 1, wherein the desired placeholder information includes Unicode text.

4. The system of claim 1, wherein the desired placeholder information includes at least one of a set of one or more solid boxes, a set of one or more characters conveying information, a set of one or more characters spelling a phrase of one or more terms, a randomized set of one or more characters, a set of one or more space characters, blurred text, and blurred image.

5. The system of claim 1, wherein the selected desired methodology is manual methodology, and the content includes one or more of a set of one or more characters, images, and pages.

6. The system of claim 1, wherein the selected desired methodology is search methodology, and the terms are provided by the user by the user inputting one or more characters of a search phrase of one or more terms.

7. The system of claim 1, wherein the selected desired methodology is image methodology, and the images are detected by one or more of hard programming, artificial intelligence, machine learning, and computer vision.

8. The system of claim 1, wherein the selected desired methodology is pattern methodology, and the format is one or more of email address format, phone number format, name format, date format, currency format, Uniform Resource Locator format, Internet Protocol format, credit card number format, debit card number format, company name format, address format, zip code format, postal code format, location format, government-issued identification number format, company-issued identification number format, social security number format, and identification number format.

9. The system of claim 1, wherein the selected desired methodology is document methodology, and the selection of the type of document is achieved by one or more of the user selecting the type of document and the system detecting the type of document.

10. The system of claim 9, wherein the type of document is detected by one or more of hard programming, artificial intelligence, machine learning, and computer vision.

11. The system of claim 9, wherein the sensitive content is information known to be in a least one of a known format and a known location in the type of document.

12. The system of claim 11, wherein the known information is so known based on a pre-established association of one or more of the known format and the known location with the type of document.

13. The system of claim 11, wherein the sensitive content is information is detected by, when the known information is information known to be in the known format in the type of document, the system searching in the document for any content in the known format, and the system finding in the document all content in the known format.

14. The system of claim 11, wherein the sensitive content is information is detected by, when the known information is known to be in the known location in the type of document, the system searching in the document for any content in the known location, and the system finding in the document all content at the known location.

15. The system of claim 1, wherein the document is provided by the user to the system in a file type, and the redacted version of the document is saved in the file type, and during identifying the information to be redacted, marking the identified information to be redacted, performing redaction on the marked information, and saving the redacted version of the document, the file type of the document is maintained unchanged from the file type.

16. The system of claim 15, wherein the file type is one of an Adobe file type, a Microsoft file type, an Apple file type, and an open-source file type.

17. The system of claim 16, wherein the file type is Portable Document Format.

18. The system of claim 15, wherein the maintenance of the document unchanged from the file type is achieved by detecting the file type, associating the file type with a container specific to the file type, obtaining content from the document in a manner specific to the file type, storing the content in a cache, displaying the cached content in the container so as to appear as the content would in the document, tracking in a log desired changes to the cached content, and displaying changed cached content in the container so as to appear as the changed cached content would in the document, the changed cached content being the cached content as modified according to the changes indicated in the log.

19. The system of claim 18, wherein the container is configured to accept the cached content as input and apply conditions to present the cached content as it would appear in the file type to which the container is specific.

20. The system of claim 18, wherein tracking the desired changes in the log includes recording at least one of a location of the change and the change to be made.
